(19) United States
(12) Patent Application Publication
(10) Pub. No.: US 2012/0234171 A1
(43) Pub. Date: Sep. 20, 2012

(54) SYSTEM FOR DEGASSING A LIQUID

(76) Inventor: Charles Solomon, Collinsville, TX (US)

(21) Appl. No.: 13/052,062

(22) Filed: Mar. 19, 2011

(51) Int. Cl. B01D 19/00

(52) U.S. Cl. 96/6

(57) ABSTRACT

One example embodiment includes a system for degassing a liquid. The system includes a first chamber, where a liquid flows through the first chamber. The system also includes a second chamber, where the second chamber is configured to contain one of a vacuum or a sweep gas. The system further includes a membrane, wherein the membrane allows a gas to pass between the first chamber and the second chamber.

### CROSS-REFERENCE TO RELATED APPLICATIONS

Not applicable.

### BACKGROUND OF THE INVENTION

Water is used in many ways in oil drilling and other means of obtaining natural resources. In particular, during oil drilling, water is pumped down a well in order to maintain the pressure of the well. I.e., as the oil is removed, it is replaced with water in order to keep the pressure of oil high enough to allow the oil to be recovered. Other materials can be used but water is convenient because of its relative abundance, its ready availability and its low cost.

However, many times the water must be prepared before it can be used. For example, the water may need to be treated before it is used. I.e., it must be completely or significantly free of microbes. This is because failure to treat the water can result in growth within the pipes which can inhibit the water flow. Additionally, the microbes may be able to break down or otherwise corrode the pipe. This can lead to breaks and/or costly repairs.

Additionally, the water often must be degassed. I.e., gases from the atmosphere will naturally dissolve into the water. This gas can damage equipment or promote microbial growth, leading to the problems discussed above and the souring of the formation. Additionally, the gas may form bubbles or create pressure when leaving the water, creating a burst hazard that can be dangerous to equipment and workers.

The degassing of water generally takes large equipment to accomplish. The water is pumped through a machine and exposed to a vacuum. The dissolved gases then naturally evaporate out of the water and are removed. However, if the volume of water is large or the percentage of gas to be removed is high, then the exposure time of the water to the vacuum must be large. This is because the gas must defuse through the water in order to be removed. I.e., only gases at or near the surface can escape. Consequently, the water must be exposed to the vacuum for a sufficient time for the gases to diffuse through the water and be removed. This can be an extremely large problem, especially at sites where space is at a premium. Additionally a chemical is added to achieve the levels of de-gassing necessary to prevent microbial growth.

Since these machines are large, they are normally custom built. This means the system must be designed to accommodate future expansion and flow rates making the initial capital cost high and the footprint and weight excessive in the preliminary treatment stage.

These problems can work hand-in-hand with one another. For example, custom building each machine means that it must be even larger, in order to allow changes in demand to be made as needed. Further, the amount of exposure time can vary depending on the amount of dissolved gas. This often requires a custom solution to ensure that the water is degassed to the proper specifications. This hampers efforts to produce a single device that can be used in most or all situations.

Moreover, the custom nature of the degassing machines can make repairs difficult. Parts may be custom built, leading to a large lag time before new parts can be fabricated, tested, shipped and installed. Even minor problems may take a large amount of time to be resolved because of the custom nature of the parts.

Accordingly, there is a need in the art for a system that can degas water in different environments and for different uses. Additionally, there is a need for the system to be mobile for use at different sites. Further, there is a need in the art for the system to use standard parts which allow repairs to be accomplished easier. Moreover, there is a need in the art for the system to allow the amount of water processed to be varied as needed. In addition, there is a need for the system to be capable of treating the water to remove oxygen.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for degassing a liquid. The system includes a first chamber, where a liquid flows through the first chamber. The system also includes a second chamber, where the second chamber is configured to contain one of a vacuum or a sweep gas. The system further includes a membrane, wherein the membrane allows a gas to pass between the first chamber and the second chamber.

Another example embodiment includes a system for degassing a liquid. The system includes a first chamber, where a liquid flows through the first chamber, and a second chamber, where the second chamber is configured to contain a sweep gas. The system also includes a membrane, where the membrane allows a gas to pass between the first chamber and the second chamber, and a treatment system, wherein the treatment system is configured to add a chemical to the liquid configured to kill microbes present in the liquid.

Another example embodiment includes a system for degassing a liquid. The system includes a first cartridge. The first cartridge includes a first chamber, where a liquid flows through the first chamber, and a second chamber, where the second chamber is configured to contain a sweep gas. The first cartridge also includes a membrane, where the membrane allows a gas to pass between the first chamber and the second chamber. The system also includes a second cartridge. The first cartridge includes a first chamber, where the liquid flows through the first chamber, and a second chamber, where the second chamber is configured to contain the sweep gas. The second cartridge also includes a membrane, where the membrane allows the gas to pass between the first chamber and the second chamber.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for degassing a liquid;

FIG. 2A illustrates an example of cartridges connected in parallel to one another;

FIG. 2B illustrates an example of cartridges connected in series to one another;

FIG. 3 illustrates a cross-section of an example of a cartridge; and

FIG. 4 illustrates an example of degassing a liquid.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

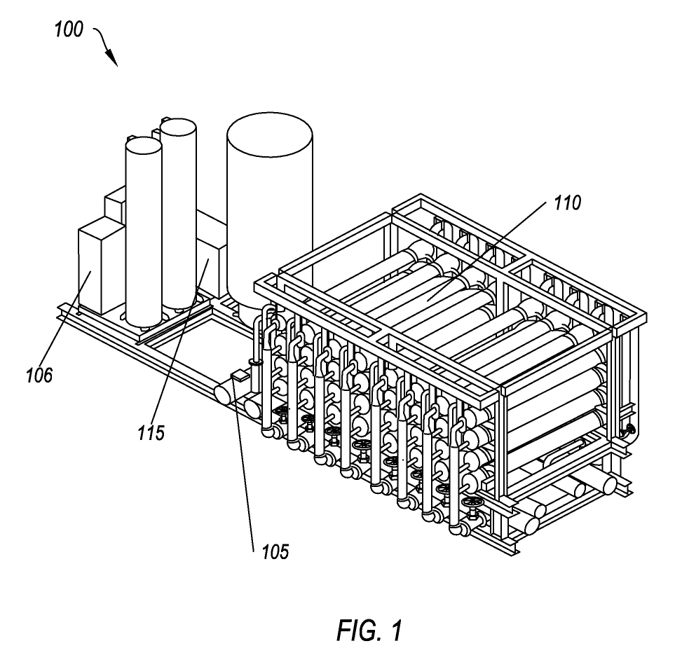

FIG. 1 illustrates an example of a system 100 for degassing a liquid. In at least one implementation, degassed liquid can be used in a number of applications. For example, during oil drilling water is sometimes pumped down the well in order to maintain the pressure of oil flowing up through the installed piping. Degassing the water can help prevent corrosion and bacterial growth.

In at least one implementation, the system 100 is capable of removing all or substantially all the gas in the source liquid. For example, the system 100 can be used to ensure that the gas level of the liquid is below 15 parts-per-billion (ppb). In particular, the system 100 can be used to ensure that that gas level of the liquid is below approximately 10 ppb. As used in the specification and the claims, the term approximately shall mean that the value is within 10% of the stated value, unless otherwise specified.

One of skill in the art will appreciate that parts-per notation is used, especially in science and engineering, to denote relative proportions in measured quantities; particularly in low-value (high-ratio) proportions at the parts-per-million (ppm) 10⁻⁶, parts-per-billion (ppb) 10⁻⁹, parts-per-trillion (ppt) 10⁻¹², and parts-per-quadrillion (ppq) 10⁻¹⁵ level. Since parts-per notations are quantity-per-quantity measures, they are known as dimensionless quantities; that is, they are pure numbers with no associated units of measurement. I.e., parts-per notations generally take the literal “parts per” meaning of a comparative ratio. However, in mathematical expressions, parts-per notations function as coefficients with values less than 1. Parts-per notation is often used in the measure of dilutions (concentrations) in chemistry; for instance, for measuring the relative abundance of dissolved minerals or pollutants in liquid. The expression “1 ppm” means a given property exists at a relative proportion of one part per million parts examined, as would occur if a liquid-borne pollutant was present at a concentration of one-millionth of a gram per gram of sample solution.

In at least one implementation, the system 100 can include all necessary equipment to degas the liquid. This allows the system 100 to be conveniently transported to remote sites, such as off shore drilling sites, where shipping parts individually would be inconvenient. For example, the entire system can weigh under 15 tons when fully assembled. The system can then be loaded on truck, ship, plane train or any other shipping system for transport to a remote location.

FIG. 1 shows that the system 100 can include a vacuum pump 105. In at least one implementation, the vacuum pump 105 is used to remove air from the system 100. I.e., the vacuum pump 105 can be used to create a vacuum within the system 100. Removing air from the system 100 can allow the gas to be removed from the liquid, as described below. Additionally or alternatively, the vacuum pump 105 can be used to move a sweep gas through the system 100, as described below. For example, the vacuum pump 105 can create a vacuum which, in turn, creates a pressure differential that pulls the sweep gas through the system 100.

FIG. 1 also shows that the system 100 can include one or more cartridge 110. In at least one implementation, the liquid flows through the one or more cartridges 110 where gas can be removed from the liquid, as described below. In at least one implementation, the one or more cartridges 110 can be connected in series, in parallel, or some combination thereof. I.e., the liquid can flow through each cartridge 110 in turn or the source can be divided, with each portion flowing through a different cartridge 110. The reverse return piping design system enables an equal flow rate through each cartridge 110.

FIG. 1 shows that the system 100 includes a nitrogen producer 106. In at least one implementation, the nitrogen producer 106 is configured to generates nitrogen. The nitrogen can be produced from air in the atmosphere or from some other source. The nitrogen can be used as the sweep gas for degassing the liquid, as described below.

FIG. 1 further shows that the system 100 can include a treatment system 115. In at least one implementation, the treatment system 115 can be used to kill some or all microbes present within the liquid. For example, the treatment system 115 can include a chlorine dioxide (ClO2) generation system. Additionally or alternatively, the treatment system 115 can filter the liquid to remove any microbes from the liquid.

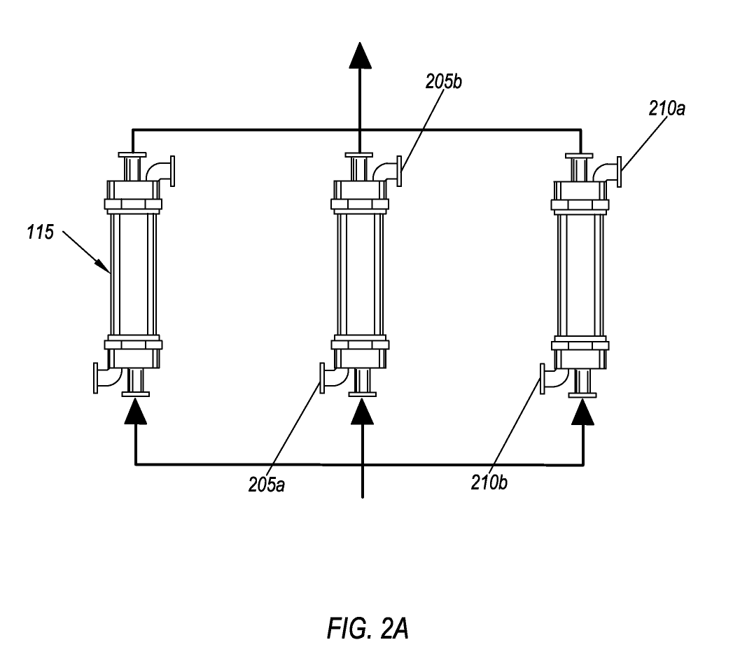

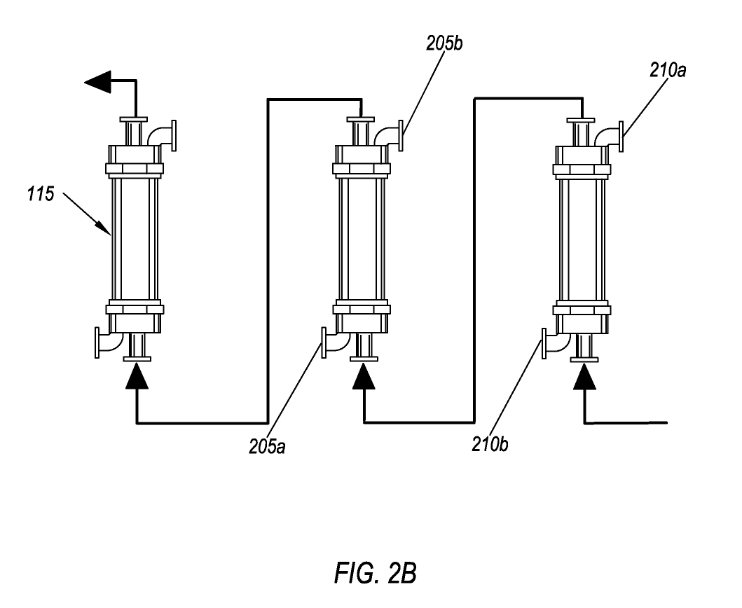

FIGS. 2A and 2B illustrate an example of cartridges 110 connected to one another. FIG. 2A illustrates an example of cartridges 110 connected in parallel to one another; and FIG. 2B illustrates an example of cartridges 110 connected in series to one another. In at least one implementation, the cartridge 110 is configured to degas a liquid. That is, the liquid exiting the cartridge 110 has a lower concentration of gas that the liquid the entering cartridge 110. In particular, the cartridge 110 can remove dissolved gas from the liquid, as described below. For example, the cartridge 110 can be used to deoxygenate water.

In at least one implementation, connecting the cartridges 110 in parallel can allow a larger volume of the liquid to be degassed. In particular, the liquid can be divided into smaller volumes which are each degassed in a separate cartridge 110. The output of each cartridge is then combined and output.

In at least one implementation, connecting the cartridges 110 in series can allow more gas to be removed from the liquid. In particular, the liquid can pass through a first cartridge 110 where gas is removed. The output of the first cartridge 110 can be connected to the input of a second cartridge 110 where additional gas is removed. For example, if the cartridges 110 each remove 99% of the gas, then putting the cartridges 110 in series can remove 99.99% of the gas.

FIGS. 2A and 2B shows that the cartridges 110 can include a first liquid port 205a and a second liquid port 205b (collectively “liquid ports 205”). In at least one implementation, the liquid ports 205 can allow liquid to flow through the cartridge 110. In particular, the liquid can be pumped through the first liquid port 205a into the cartridge 110 and out the second liquid port 205b. Additionally or alternatively, the liquid can be pumped out the second liquid port 205b which will pull liquid through the first liquid port 205a.

FIGS. 2A and 2B also shows that the cartridges 110 can include a first gas port 210a and a second gas port 210b (collectively “gas ports 210”). In at least one implementation, the gas ports 210 can allow the gas removed from the liquid to be removed from the cartridge 110. For example, the gas ports 210 can be used to create a vacuum within the cartridge to decrease the partial pressure of gas within the cartridge 110. One of skill in the art will appreciate that a vacuum pump can be attached to the first gas port 210a, the second gas port 210b or both gas ports 210 simultaneously to remove gas from the cartridge 110. Additionally or alternatively, the gas ports 210 can be used to pass a sweep gas through the cartridge 110, where the sweep gas is a gas configured to decrease the partial pressure of gas within the cartridge 110, as described below.

In at least one implementation, the sweep gas can include any gas which does not contain the gas to be removed. For example, the sweep gas can include an inert gas, such as nitrogen. Additionally or alternatively, the sweep gas can include a gas which will react readily with the gas to be removed, creating a byproduct which can be removed from the cartridge 110.

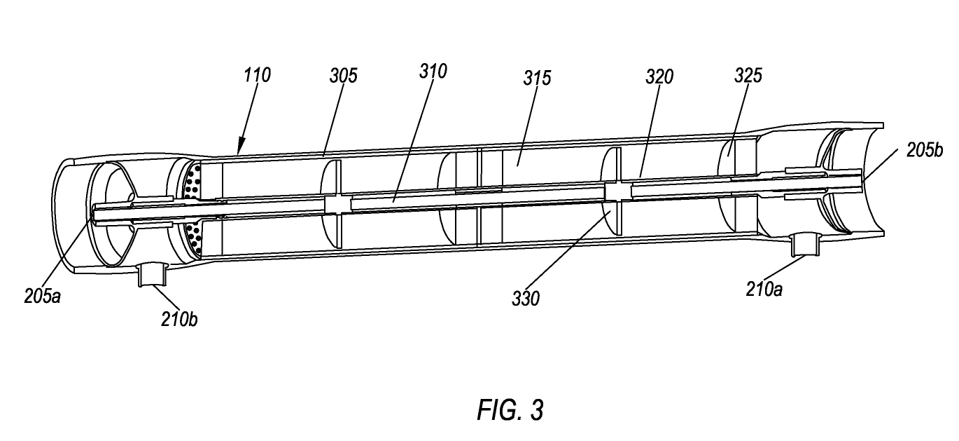

FIG. 3 illustrates a cross-section of an example of a cartridge 110. In at least one implementation, the cartridge 110 can allow for easy adjustment and repair. For example, if the volume of water to be treated has changed then more or fewer cartridges 110 can be used to make adjustments to the volume of liquid that can be treated. Additionally or alternatively, if a single cartridge 110 is damaged, it can be replaced without disrupting the flow through other cartridges 110.

FIG. 3 shows that the cartridge 110 can include a housing 305. In at least one implementation, the housing 305 can be used to contain the other parts of the cartridge 110. Additionally or alternatively, the housing 305 can protect delicate or easily damaged portions of the cartridge 110. One of skill in the art will appreciate that the housing 110 can allow the cartridge 110 to be easily replaced and can allow the cartridge 110 to be installed and supported as desired.

FIG. 3 shows that the cartridge 110 can include a first chamber 310. In at least one implementation, the first chamber 310 allows liquid to flow through the cartridge 110. I.e., the liquid flows into the liquid inlet 205a, flows through the first chamber 310 and then exits through the liquid outlet 205b. As the liquid flows through the first chamber 310, the gas content of the liquid can be decreased, as described below.

FIG. 3 also shows that the cartridge 110 can include a second chamber 315. In at least one implementation, the second chamber 315 allows a sweep gas to flow through the cartridge 110. I.e., the sweep gas flows into the gas inlet 210a, flows through the second chamber 315 and then exits through the gas outlet 210b. As the liquid flows through the second chamber 315, the gas content of the liquid can be decreased. Additionally or alternatively, the second chamber 315 can be continuously evacuated using a vacuum pump, as described above.

FIG. 3 further shows that the first chamber 310 can reside within the second chamber 315. This can allow the liquid within the first chamber 310 to pass gas to or receive gas from the second chamber 315, as described below. One of skill in the art will appreciate that the first chamber 310 can have any spatial relationship relative to the second chamber 315. For example, the second chamber 315 can reside within the first chamber 310. Additionally or alternatively, the first chamber 310 and the second chamber 315 can reside side by side within the cartridge 110 or can have any other desired configuration.

One of skill in the art will appreciate that the direction of gas flow through the second chamber 315 need not be the same as the direction of liquid flow through the first chamber 310, although the directions may be the same. In particular, the cartridge 110 can allow gas to flow out of the second chamber 315 through one or both of the gas ports 210. One of skill in the art will appreciate that having the direction of fluid flow opposite the direction of gas flow can allow the sweep gas with the lowest partial pressure of gas to be located where the gas content of the liquid is lowest.

FIG. 3 also shows that the cartridge 110 can include a membrane 320. In at least one implementation, the membrane 320 is a layer of material which serves as a selective barrier between the first chamber 310 and the second chamber 315. I.e., the membrane 320 allows some particles, molecules, or substances to pass while restricting others. The membrane 320 can be of various thickness, with homogeneous or heterogeneous structure.

In at least one implementation, the membrane 320 can be configured based on the components to be removed from the liquid stream. For example, polyolefin can be used with low surface tension fluids. One of skill in the art will appreciate that the use of any membrane 320 is contemplated herein unless otherwise specified in the specification or claims.

FIG. 3 further shows that the cartridge 110 can include one or more supports 325. In at least one implementation, the one or more supports 325 can hold the first chamber 310 relative to the second chamber 315. In particular, much of the outside of the first chamber 310 can include the membrane 320 and can be intended for gas exchange between the first chamber 310 and the second chamber 315. The one or more supports 325 can be used to hold the other portions of the first chamber 310.

FIG. 3 also shows that the one or more supports 325 can include one or more baffles 330. In at least one implementation, the one or more baffles 330 are flow-directing or obstructing vanes or panels used to direct air flow through the second chamber 315. For example, the one or more baffles 330 can include holes which allow the air to flow within the second chamber 315. Additionally or alternatively, the one or more baffles 330 can includes open portions of the one or more supports 325.

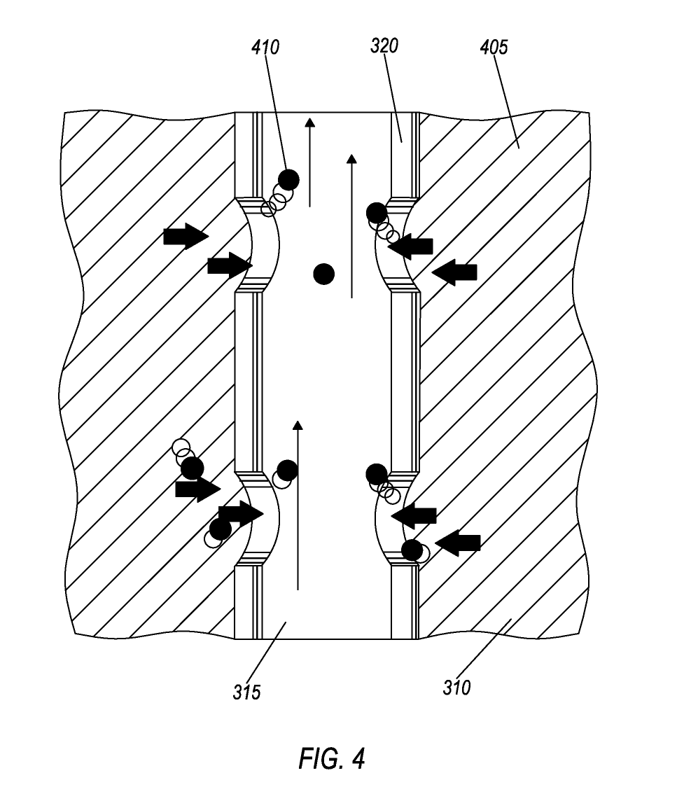

FIG. 4 illustrates an example of degassing a liquid 405. In at least one implementation, degassing can remove a gas dissolved in the liquid 405. For example, degassing can involve removing oxygen dissolved in water. The liquid 405 can be in a chamber, such as the first chamber 310 of FIG. 3.

FIG. 4 shows that the liquid 405 in the first chamber 310 includes dissolved gas molecules 410. In at least one implementation, the gas molecules 410 dissolve into the liquid 405 from the atmosphere. After sufficient time the gas molecules 410 dissolved in the liquid 405 and the gas molecules 410 molecules in the atmosphere reach an equilibrium state. I.e., the amount of gas molecules 410 dissolved in the liquid 405 reaches a steady state. In some liquids 405, such as water, this cannot be avoided as the liquid 405 is in contract with the atmosphere for long periods of time.

FIG. 4 also shows that the gas molecules 410 pass through the membrane 320 into the second chamber 315. In at least one implementation, the amount of dissolved gas molecules 410 is governed by Henry's law. Henry's law states that at a constant temperature, the amount of a given gas molecule 410 dissolved in a given type and volume of liquid 405 is directly proportional to the partial pressure of that gas molecule 410 in equilibrium with that liquid 405. I.e., the solubility of a gas molecule 410 in a liquid 405 at a particular temperature is proportional to the pressure of that gas molecule 410 above the liquid 405. In mathematical terms, Henry's law states that (at constant temperature) p=k_{H}*c where p is the partial pressure of the gas molecules 410 in the second chamber 315, c is the concentration of the gas molecules 410 in the first chamber 310 and k_{H} is Henry's proportionality constant. In a mixture of gases, each gas molecules 410 has a partial pressure which is the pressure which the gas molecules 410 would have if it alone occupied the volume. I.e., the total pressure of a gas molecules 410 mixture is the sum of the partial pressures of each individual gas molecule 410 in the mixture. Henry's proportionality constant of the gas molecule 410 depends on the type of gas molecule 410, the liquid 405 and the temperature.

FIG. 4 shows that by lowering the partial pressure of the gas molecules 410 (e.g., through the creation of a vacuum, the introduction of a sweep gas or a combination thereof) the equilibrium of dissolved gas molecules 410 is disrupted. This creates diffusion of the gas molecules 410 from the first chamber 310 to the second chamber 315. I.e., gas molecules 410 will exit the liquid 405 more rapidly than they enter, reducing the concentration of gas molecules 410 within the liquid 405.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for degassing a liquid, the system comprising:
a first chamber, wherein a liquid flows through the first chamber;
a second chamber, wherein the second chamber is configured to contain one of:
a vacuum; or
a sweep gas; and
a membrane, wherein the membrane allows a gas to pass between the first chamber and the second chamber.

2. The system of claim 1, wherein the direction of liquid flow in the first chamber is the same direction as the direction of flow in the second chamber.

3. The system of claim 1, wherein the direction of liquid flow in the first chamber is the opposite direction as the direction of flow in the second chamber.

4. The system of claim 1, wherein the sweep gas includes nitrogen.

5. The system of claim 1, wherein the first chamber is located within the interior of the second chamber.

6. The system of claim 5 further comprising one or more supports, wherein the one or more supports are configured to hold the position of the first chamber relative to the position of the second chamber.

7. The system of claim 1, wherein the second chamber is located within the interior of the first chamber.

8. The system of claim 7 further comprising one or more supports, wherein the one or more supports are configured to hold the position of the second chamber relative to the position of the first chamber.

9. The system of claim 1 further comprising a baffle in the second chamber, wherein the baffle directs the flow of the sweep gas.

10. The system of claim 9, wherein the baffle includes one or more holes to allow the sweep gas to pass through the baffle.

11. A system for degassing a liquid, the system comprising:
a first chamber, wherein a liquid flows through the first chamber;
a second chamber, wherein the second chamber is configured to contain a sweep gas;
a membrane, wherein the membrane allows a gas to pass between the first chamber and the second chamber; and
a treatment system, wherein the treatment system is configured to add a chemical to the liquid configured to kill microbes present in the liquid.

12. The system of claim 11 further comprising a pump, wherein the pump is configured to move liquid through the first chamber.

13. The system of claim 11 further comprising a vacuum pump, wherein the vacuum pump is configured to move the sweep gas through the second chamber.

14. The system of claim 11, wherein the liquid includes water.

15. The system of claim 11, wherein the gas includes oxygen.

16. The system of claim 11, wherein treatment system adds chlorine dioxide into the liquid.

17. A system for degassing a liquid, the system comprising:
a first cartridge, wherein the first cartridge includes:
a first chamber, wherein a liquid flows through the first chamber;
a second chamber, wherein the second chamber is configured to contain a sweep gas; and
a membrane, wherein the membrane allows a gas to pass between the first chamber and the second chamber; and
a second cartridge, wherein the first cartridge includes:
a first chamber, wherein the liquid flows through the first chamber;
a second chamber, wherein the second chamber is configured to contain the sweep gas; and
a membrane, wherein the membrane allows the gas to pass between the first chamber and the second chamber.

18. The system of claim 17, wherein the first cartridge is arranged in parallel with the second cartridge.

19. The system of claim 17, wherein the first cartridge is arranged in series with the second cartridge.

20. The system of claim 17 further comprising a third cartridge, wherein the third cartridge includes:
a first chamber, wherein the liquid flows through the first chamber;
a second chamber, wherein the second chamber is configured to contain the sweep gas; and
a membrane, wherein the membrane allows the gas to pass between the first chamber and the second chamber
